(19) United States
(12) Patent Application Publication
(10) Pub. No.: US 2025/0335693 A1
(43) Pub. Date: Oct. 30, 2025

(54) MERGER OF EMBEDDED FONTS IN ELECTRONIC FILES

(71) Applicant: Johnathon McAlister, Helena, MT (US)

(72) Inventor: Johnathon McAlister, Helena, MT (US)

(73) Assignee: Ricoh Company, Ltd., Tokyo (JP)

(21) Appl. No.: 18/651,682

(22) Filed: Apr. 30, 2024

(51) Int. Cl. G06F 40/109

(52) U.S. Cl. CPC G06F 40/109

(57) ABSTRACT

Apparatus and methods for merging embedded fonts. In an embodiment, an apparatus is configured to identify embedded fonts in a plurality of electronic files, identify glyphs represented in the embedded fonts, generate a synthesized font subset comprising a union of the glyphs found in the embedded fonts, and assign glyph code points to the glyphs of the synthesized font subset.

### TECHNICAL FIELD

The following disclosure relates to the field of image formation, and in particular, to embedded fonts in electronic files.

### BACKGROUND

Image formation is a procedure whereby one or more digital images are recreated by applying a recording or marking material (e.g., ink, toner, etc.) to a printable medium, such as paper. As an example, an image forming apparatus, such as a printer, may receive an electronic file (e.g., a Portable Document Format (PDF) file) for printing. The image forming apparatus transforms the electronic file into one or more digital images, and then marks a printable medium based on the digital images. Electronic files that use text may have embedded fonts, where one or more font files are included or embedded in the electronic file. Font embedding may be full font embedding or subset font embedding. In full font embedding, a full copy of the entire character set of a font is stored in the electronic file. In subset font embedding, a subset of a font (i.e., only the characters that are actually used in the lay-out) is stored in the electronic file.

One potential issue may arise when multiple electronic files that use font embedding are combined into a single, combined file. Presently, the combined file may be embedded with the fonts (i.e., full fonts or font subsets) of the individual electronic files, which can make the combined file quite large.

### SUMMARY

Embodiments described herein provide an improved mechanism for merging embedded fonts. As a general overview, a character of a font comprises a glyph, and a code point assigned to the character within the context of that font. Different code points may be associated with the same glyph across different embedded fonts depending on the character encoding. For example, the letter “B” may be assigned a code point of “0001” (hexadecimal) within the context of one embedded font, and may be assigned a code point of “0002” (hexadecimal) within the context of another embedded font. Thus, even when glyphs overlap among embedded fonts, the code points associated with the glyphs may not. An improved mechanism described herein searches for the glyphs represented in the embedded fonts of the electronic files, and builds a synthesized font subset comprising the union of the glyphs found. The improved mechanism assigns code points to the glyphs within the context of the synthesized font subset, and may also map the glyphs to the previously-assigned code points within the context of the embedded fonts. When the electronic files are combined, the synthesized font subset may replace the embedded fonts within the combined file. One technical benefit is the synthesized font subset is generally smaller than a collection of the embedded fonts, such as when there is overlap of glyphs between the embedded fonts. This advantageously saves processing and/or memory resources in handling the combined file (e.g., at a printer), saves networking resources used in transmission of the combined file, etc.

In an embodiment, an apparatus comprises at least one processor and memory. The at least one processor is configured to cause the apparatus at least to identify embedded fonts in a plurality of electronic files, identify glyphs represented in the embedded fonts, generate a synthesized font subset comprising a union of the glyphs found in the embedded fonts, and assign glyph code points to the glyphs of the synthesized font subset.

In an embodiment, a method comprises identifying embedded fonts in a plurality of electronic files, identifying glyphs represented in the embedded fonts, generating a synthesized font subset comprising a union of the glyphs found in the embedded fonts, and assigning glyph code points to the glyphs of the synthesized font subset.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a diagram of a print system in an illustrative embodiment.

FIG. 2 is a schematic diagram of an image forming apparatus in an illustrative embodiment.

FIG. 3 is a diagram of a print system in another illustrative embodiment.

FIG. 4 is a block diagram illustrating file merging in an illustrative embodiment.

FIG. 5 is a block diagram of an electronic file in an illustrative embodiment.

FIG. 6 is a block diagram of a utility system in an illustrative embodiment.

FIG. 7 is a flow chart illustrating a method of combining electronic files in an illustrative embodiment.

FIG. 8 is a flow chart illustrating a method of merging embedded fonts in an illustrative embodiment.

FIG. 9A is a block diagram illustrating an embedded font in an illustrative embodiment.

FIG. 9B illustrates a glyph in an illustrative embodiment.

FIG. 10 is a block diagram illustrating a synthesized font subset in an illustrative embodiment.

FIG. 11 is a flow chart illustrating a method of building a synthesized font subset in an illustrative embodiment.

FIGS. 12A-12B are block diagrams of a hash table in illustrative embodiments.

FIG. 13 is a block diagram illustrating a synthesized font subset in an illustrative embodiment.

FIG. 14 is a flow chart illustrating a method of modifying a combined file in an illustrative embodiment.

FIG. 15 is a block diagram illustrating file merging in another illustrative embodiment.

FIG. 16 is a block diagram illustrating file merging in another illustrative embodiment.

FIG. 17 is a block diagram of a hash table in another illustrative embodiment.

FIG. 18 is a block diagram illustrating a synthesized font subset in an illustrative embodiment.

FIG. 19 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

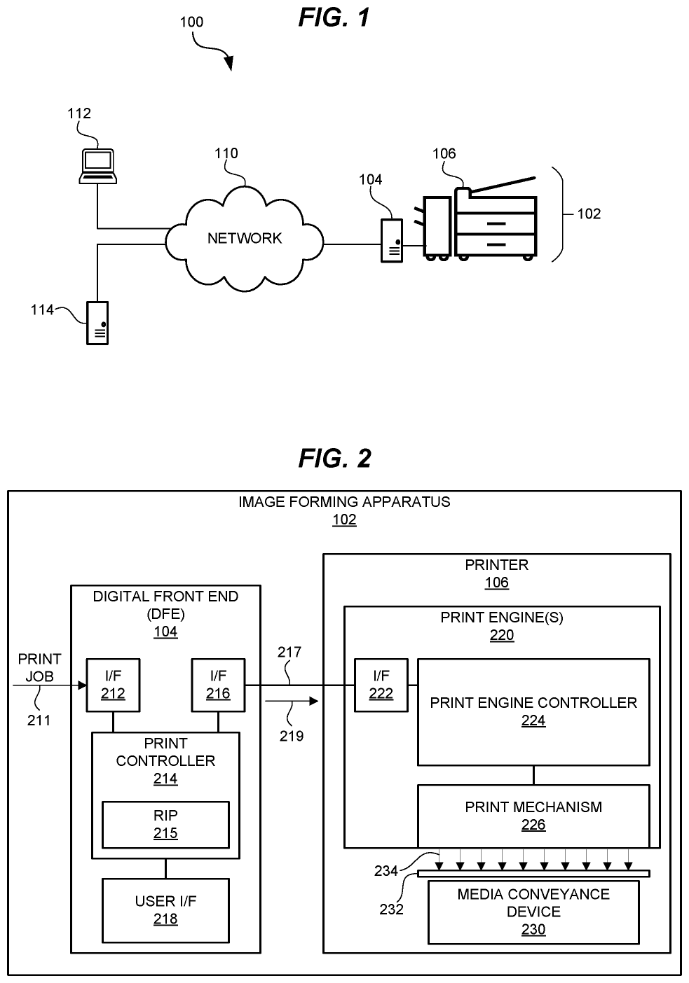

FIG. 1 is a diagram of a print system 100 in an illustrative embodiment. As one example in FIG. 1, print system 100 may include an image forming apparatus 102 (or multiple image forming apparatuses), one or more client terminals 112 (e.g., a personal computer (PC)), and one or more management servers 114 (also referred to as a print server). As illustrated in FIG. 1, one or more of the devices of print system 100 are able to perform data communication with one another via a network 110. The network 110 may comprise, for example, a network including a local area network (LAN), a wide area network (WAN), such as the Internet, etc., and may comprise a wired network, a wireless network, or a network including both of a wired network and a wireless network.

An image forming apparatus 102 includes a digital front end (DFE) 104 and a printer 106. In an example, printer 106 may comprise an apparatus that performs image formation (printing) on a recording medium by applying colorants or marking/recording material on the basis of print data received from the DFE 104. DFE 104 is an information processing apparatus that receives a print job (e.g., from the client terminal 112 or management server 114), generates print data by a raster image processor (RIP) engine on the basis of the print job, and transmits the print data to the printer 106. In an embodiment, DFE 104 may be on-ground or on-premises with printer 106. In general, “on-premises” means that the infrastructure exists on-site in contrast to being hosted off-site. DFE 104 may be implemented on a separate (on-premises) platform from printer 106, or may be integrated on a platform of the printer 106. In an embodiment, DFE 104 may communicate with printer 106 over network 110.

The client terminal 112 is an information processing apparatus or end user device that generates a print job to be printed by a user, and transmits the print job to the DFE 104 or the management server 114. The management server 114 is a server apparatus that manages print jobs received from client terminals 112, and transmits the print jobs to the DFE 104, such as in response to requests from the DFE 104.

Print system 100 may be configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. A PSP may own or operate a variety of printing equipment, referred to generally as a print shop. For example, a print shop may include one or more printers 106 and/or other print equipment (e.g., post-print devices, finishing devices, etc.).

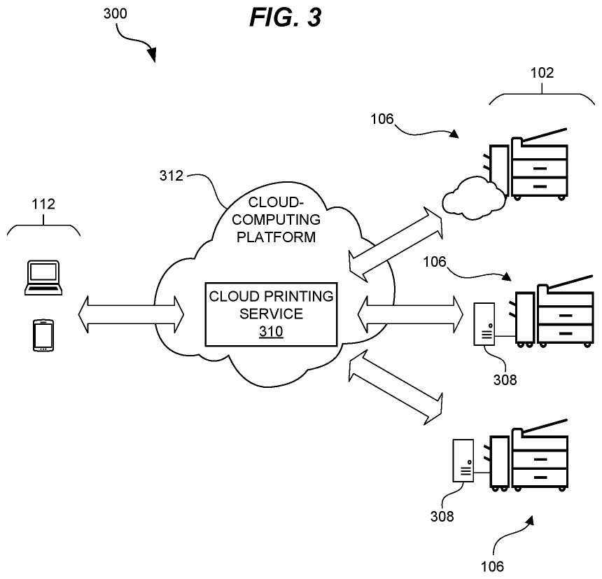

FIG. 2 is a schematic diagram of image forming apparatus 102 in an illustrative embodiment. Image forming apparatus 102 is a type of device that executes an image forming process (e.g., printing) on a recording medium. In an embodiment, image forming apparatus 102 includes DFE 104, and the printer 106 comprising one or more print engines 220. DFE 104 comprises an apparatus, device, circuitry, means, and/or other component configured to accept a print job 211, and convert the print job 211 into a suitable format for print engine 220. DFE 104 includes an Input/Output (I/O) interface 212, a print controller 214, and a print engine interface 216, and may also include a user interface 218. I/O interface 212 comprises an apparatus, device, circuitry, means, and/or other component configured to receive a print job 211 from a source, such as a client terminal 112, a management server 114, etc. I/O interface 212 may be considered a network interface in some embodiments. The print job 211 comprises one or more print files (also referred to as job files or vector files) formatted with a Page Description Language (PDL), such as PostScript, Printer Command Language (PCL), Intelligent Printer Data Stream (IPDS), etc. The print job 211 may also comprise a job ticket containing instructions, requirements, and/or other control information for processing and/or printing a print job, such as a Job Definition Format (JDF) job ticket. Print controller 214 comprises an apparatus, device, circuitry, means, and/or other component configured to transform the print job 211 into print data 219 comprising one or more digital images that may be used by print engine 220 to mark a recording medium 232 with ink, toner, or another recording or marking material. In an embodiment, print controller 214 includes a Raster Image Processor (RIP) 215 that translates or rasterizes the print job 211 to generate digital images or raster images that a printer can understand and print. A digital or raster image comprises a two-dimensional array of pixels or dots, also referred to as a bitmap. Whereas the print file(s) of the print job 211 in PDL format is a high-level description of the content (e.g., text, graphics, pictures, etc.), a digital image defines a pixel value or color value for each pixel in a display space. Print engine interface 216 comprises an apparatus, device, circuitry, means, and/or other component configured to communicate with print engine 220, such as to transmit digital images to print engine 220. Print engine interface 216 may be communicatively coupled to print engine 220 via one or more communication links 217 (e.g., a fiber link, a bus, a communication cable, etc.), and is configured to transfer the digital images to print engine 220. User interface 218 is a component configured to interact with a human operator. A human operator may access user interface 218 to view status indicators or updates, view or manipulate settings, schedule print jobs, etc.

Printer 106 may comprise a cut-sheet printer, a continuous-form printer that prints on a web of continuous-form media, a wide format printer, etc. Print engine 220 includes a DFE interface 222, a print engine controller 224, and a print mechanism 226. DFE interface 222 comprises an apparatus, device, circuitry, means, and/or other component configured to interact with DFE 104, such as to receive print data 219 from DFE 104. Print engine controller 224 comprises an apparatus, device, circuitry, means, and/or other component configured to process the print data 219 (e.g., the digital or raster images) received from DFE 104, and provide control signals to print mechanism 226. Print mechanism 226 is an image formation device (or devices) that marks the recording medium 232 with a recording material 234. Print mechanism 226 may be configured for variable droplet or dot size to reproduce multiple intensity levels. Recording medium 232 comprises any type of material suitable for printing upon which recording material 234 is applied, such as paper (web or cut-sheet), plastic, card stock, transparent sheets, cloth, etc. In an embodiment, print mechanism 226 may include one or more printheads that are configured to jet or eject droplets of a print fluid, such as ink (e.g., water-based, solvent-based, oil-based, or UV-curable), through a plurality of orifices or nozzles. The orifices or nozzles may be grouped according to ink types (e.g., colors such as Cyan (C), Magenta (M), Yellow (Y), Key black (K) or formulas such as for pre-coat, image and protector coat, etc.), which may be referred to as color planes. In another embodiment, print mechanism 226 may include a drum that selectively collects electrically-charged powdered ink (toner), and transfers the toner to recording medium 232. Media conveyance device 230 may be configured to move recording medium 232 relative to print mechanism 226. In other embodiments, portions of print mechanism 226 may be configured to move relative to recording medium 232. Image forming apparatus 102 may include various other components not specifically illustrated in FIG. 2.

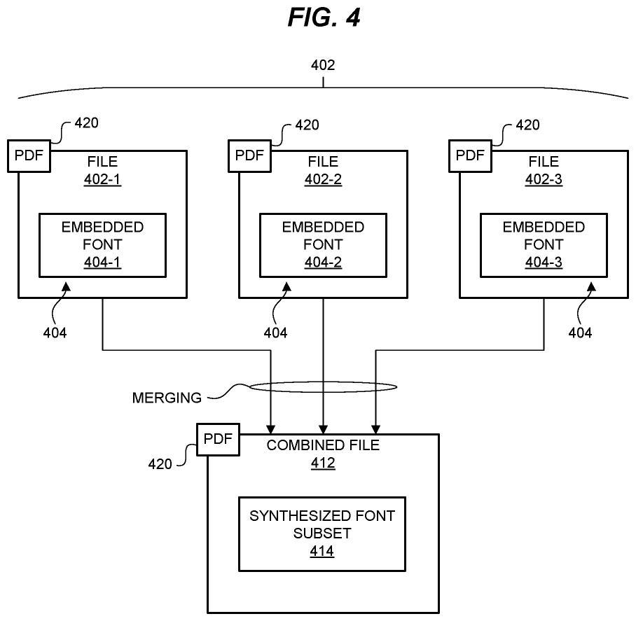

FIG. 3 is a diagram of a print system 300 in another illustrative embodiment. Print system 300 in FIG. 3 is based on a cloud printing architecture. Print system 300 comprises a cloud printing service 310 implemented on a cloud computing platform 312. Cloud-computing allows users access to a variety of services over an internet connection. Some examples of cloud computing platform 312 may comprise Amazon Web Services (AWS), Google Cloud, Microsoft Azure, etc. Cloud printing service 310 connects client terminals 112 (e.g., a smartphone, laptop, tablet, personal computer (PC), etc.) with one or more network-connected printers 106. A printer 106 used in a cloud printing architecture may comprise a cloud-ready or cloud-enabled printer configured to communicate with the cloud printing service 310. A printer 106 used in cloud printing architecture may comprise a non-cloud-enabled or legacy printer that uses a cloud print mediator 308 to communicate with the cloud printing service 310.

When a client terminal 112 is remote from a printer 106 (i.e., not directly or physically connected), the cloud printing service 310 acts as an intermediary to receive a print job from the client terminal 112, and submit the print job to the printer 106. For example, cloud printing service 310 may be used for consumer-based cloud printing, where client terminals 112 of an entity submit print jobs through the cloud printing service 310 to a printer 106 owned by the entity. Cloud printing service 310 may be used for professional or commercial cloud printing, where client terminals 112 submit print jobs through the cloud printing service 310 to printers 106 implemented at production facilities (e.g., corporate facilities, commercial facilities, etc.).

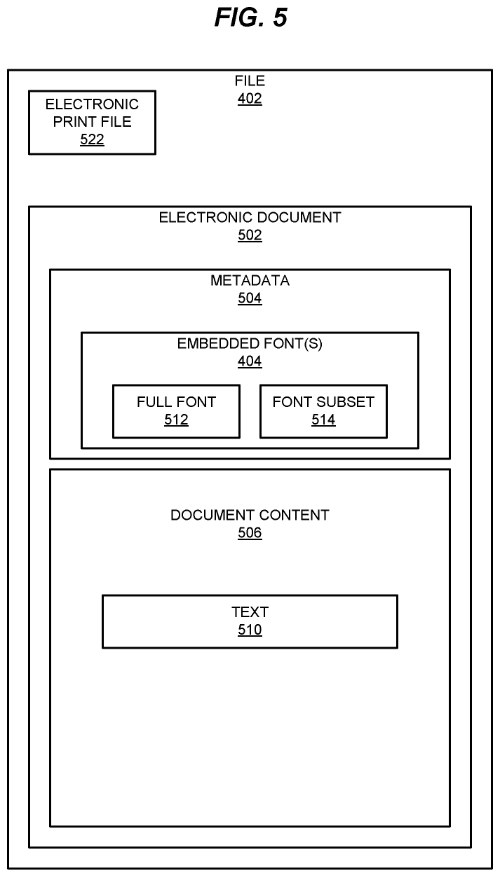

There may be instances where multiple electronic files (also referred to as print files, digital files, computer files, etc.) are merged or combined into a combined file. For example, electronic files that are set or destined for printing at a particular printer 106 may be combined for printing efficiency. FIG. 4 is a block diagram illustrating file merging in an illustrative embodiment. In this example, a plurality of electronic files 402 (e.g., electronic file 402-1, electronic file 402-2, electronic file 402-3, etc.) are merged or combined into a combined file 412, which is an electronic file 402 that contains content from each of the individual electronic files 402. For example, electronic files 402 may comprise PDF files 420 that are merged into a larger, combined PDF file, although other file types are considered herein. Although three electronic files 402 are merged in FIG. 4, more or less electronic files 402 may be merged in other embodiments.

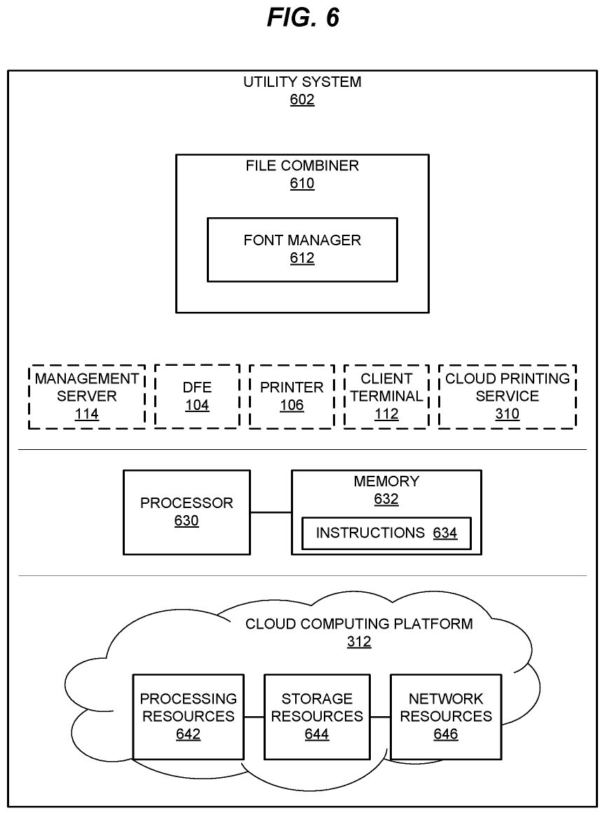

FIG. 5 is a block diagram of an electronic file 402 in an illustrative embodiment. An electronic file 402 (which may also be referred to as an electronic print file 522) is an electronic document 502 comprising metadata 504 and document content 506. The document content 506 may comprise text 510 and other content such as images and vector graphics, videos, animations, audio files, interactive fields, hyperlinks, buttons, and/or other elements, such as for presentation and/or printing on a printer. Metadata 504 comprises information about the electronic file 402, and may include one or more embedded fonts 404. As described above, font embedding is the inclusion of one or more font files inside an electronic document, so the embedded fonts 404 are included in the electronic document 502. In one example, an embedded font 404 may be a full font 512 comprising a full copy of the entire character set of a font. In an example, an embedded font 404 may be a font subset 514 comprising a subset of a font (i.e., only the characters that are actually used in the lay-out (i.e., document content 506)).

In FIG. 4, each electronic file 402 includes an embedded font 404 specific to that electronic file 402. For example, electronic file 402-1 includes an embedded font 404-1, electronic file 402-2 includes an embedded font 404-2, and electronic file 402-3 includes an embedded font 404-3. When electronic files 402 are merged into a combined file 412, handling of embedded fonts 404 may be an issue. For example, one way to handle embedded fonts 404 is to include each individual embedded font 404 in the combined file 412. However, one or more of the individual embedded fonts 404 may be relatively large and/or a large number of electronic files 402 may be merged, which may result in embedded fonts 404 of a considerable size. In embodiments described herein, font merging is performed on the individual embedded fonts 404 to merge or integrate the embedded fonts 404 into a font subset referred to herein as a synthesized font subset 414. As a general overview, font merging as described herein searches for glyphs represented in the embedded fonts 404, and builds the synthesized font subset 414 as a union of the glyphs found. Thus, each distinct glyph across the various embedded fonts 404 may be represented once in the synthesized font subset 414. One technical benefit is the size of the synthesized font subset 414 may be reduced compared to a combination of the individual embedded fonts 404, and therefore, the size of the combined file 412 may be reduced with the synthesized font subset 414 embedded. For example, there may be overlap of the glyphs represented in the individual embedded fonts 404, so the synthesized font subset 414 may be smaller in size than a combination of the individual embedded fonts 404.

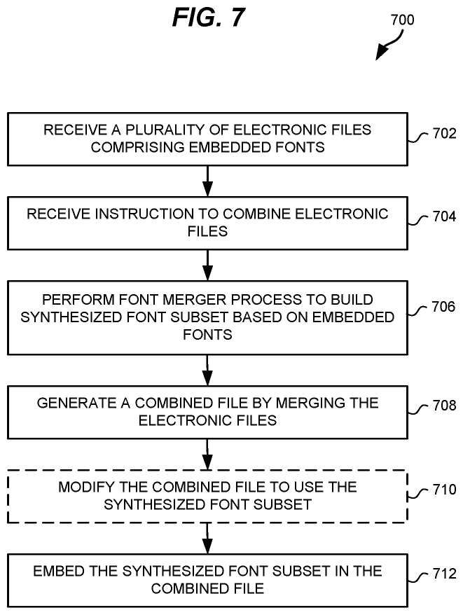

FIG. 6 is a block diagram of a utility system 602 in an illustrative embodiment. Utility system 602 is an information processing apparatus configured to merge or combine electronic files 402. Thus, utility system 602 includes or implements a file combiner 610, which comprises an apparatus, device, circuitry, means, and/or other component configured to perform a combining process to combine a plurality of electronic files 402 into a combined file 412. File combiner 610 includes or implements a font manager 612, which comprises an apparatus, device, circuitry, means, and/or other component configured to merge embedded fonts 404 in the electronic files 402 being merged or selected/instructed for merger into a combined file 412.

Utility system 602 may be implemented in a variety of devices within a print system or other systems to combine electronic files 402. As illustrated in FIG. 6, utility system 602 may be implemented in a management server 114, in a DFE 104, in a printer 106, in a client terminal 112, in a cloud printing service 310, etc. The platform of utility system 602 (and consequently, the font manager 612) may be implemented on a hardware platform comprised of analog and/or digital circuitry. The platform of utility system 602 may be implemented on a processor 630 that executes instructions 634 (i.e., computer program code) for software stored in memory 632. Processor 630 represents the internal circuitry, logic, hardware, etc., that provides the functions of utility system 602. Processor 630 may comprise a microprocessor, a set of one or more processors, or may comprise a multi-processor core depending on the particular implementation. Memory 632 is a non-transitory computer readable medium for data, instructions, applications, etc., and is accessible by processor 630. Memory 632 is a hardware storage device capable of storing information on a temporary basis and/or a permanent basis. Memory 632 may comprise a random-access memory, or any other volatile or non-volatile storage device.

The platform of utility system 602 may be implemented on a cloud computing platform 312 or another type of processing platform. Cloud resources provisioned on cloud computing platform 312 may comprise processing resources 642 (e.g., physical or hardware processors, a server, a virtual server or virtual machine (VM), a virtual central processing unit (vCPU), etc.), storage resources 644 (e.g., physical or hardware storage, virtual storage, etc.), and/or networking resources 646, although other resources are considered herein.

Utility system 602 may include other components or devices not shown in FIG. 6.

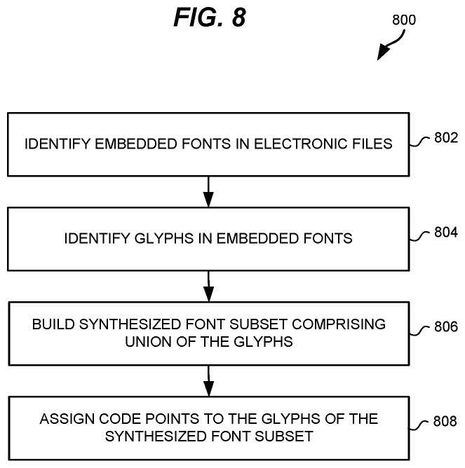

FIG. 7 is a flow chart illustrating a method 700 of combining electronic files 402 in an illustrative embodiment. Method 700 will be discussed with respect to file combiner 610 of FIG. 6, although method 700 may be performed by other systems, not shown. The steps of the flow charts described herein may include other steps that are not shown. Also, the steps of the flow charts described herein may be performed in an alternate order.

File combiner 610 receives a plurality of electronic files 402 (step 702), such as PDF files 420. The electronic files 402 received by file combiner 610 (e.g., each electronic file 402 or certain ones of the electronic files 402) include one or more embedded fonts 404. File combiner 610 receives or identifies an instruction or command to combine the electronic files 402 (step 704). File combiner 610 performs a font merger process to build a synthesized font subset 414 based on the embedded fonts 404 (step 706). File combiner 610 generates a combined file 412 by combining or merging the electronic files 402 (step 708). For example, file combiner 610 may sequentially append one electronic file 402 to the end of another electronic file 402 in generating the combined file 412, may remove or modify commands within the electronic files 402 (e.g., “Begin” or “End” commands), build or modify tree structures indicating locations of resources within the combined file 412, and/or otherwise process the electronic files 402 to merge them into combined file 412. File combiner 610 may modify the combined file 412 to use the synthesized font subset 414 (optional step 710). For example, file combiner 610 may replace, update, or modify code point references in the combined file 412 to the synthesized font subset 414 based on a code point mapping. Modification of the combined file 412 is described in further detail below. File combiner 610 embeds the synthesized font subset 414 in the combined file 412 (step 712). File combiner 610 does not embed the individual embedded fonts 404 from the electronic files 402 in the combined file 412, as the individual embedded fonts 404 are replaced with the synthesized font subset 414. One technical benefit is the synthesized font subset 414 may be smaller than a combination of the individual embedded fonts 404, and therefore, the size of the combined file 412 may be reduced with the synthesized font subset 414 embedded.

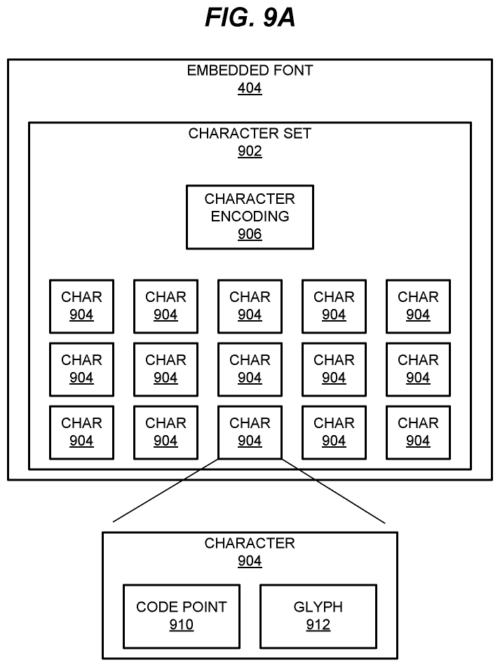

FIG. 8 is a flow chart illustrating a method 800 of merging embedded fonts 404 in an illustrative embodiment. Method 800 will be discussed with respect to font manager 612 of FIG. 6, although method 800 may be performed by other systems, not shown.

Method 800 represents a font merger process, such as described in step 706 above. The font merger process may be performed via a program, script, algorithm, etc., configured to trigger (e.g., automatically) when combining electronic files 402. For the font merger process, font manager 612 identifies the embedded fonts 404 in the electronic files 402 instructed for merger into a combined file 412 (step 802). For example, font manager 612 may parse (e.g., automatically) each of the electronic files 402 to identify any embedded fonts 404 embedded in the electronic files 402. Font manager 612 identifies or searches for glyphs represented in the embedded fonts 404 (step 804). For example, font manager 612 may parse or scan (e.g., automatically) the embedded fonts 404 to identify each distinct glyph represented or included in the embedded fonts 404.

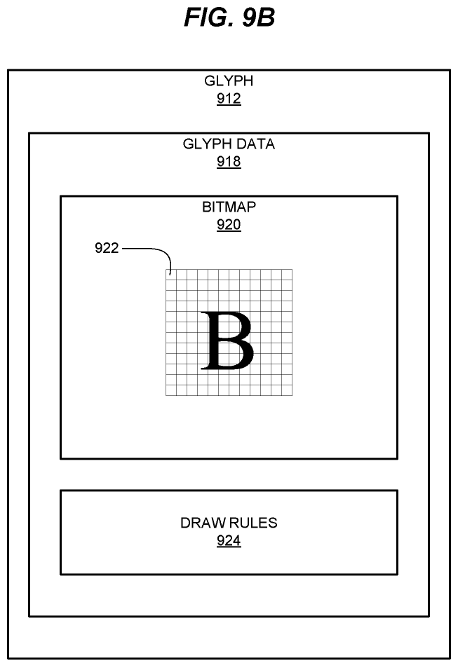

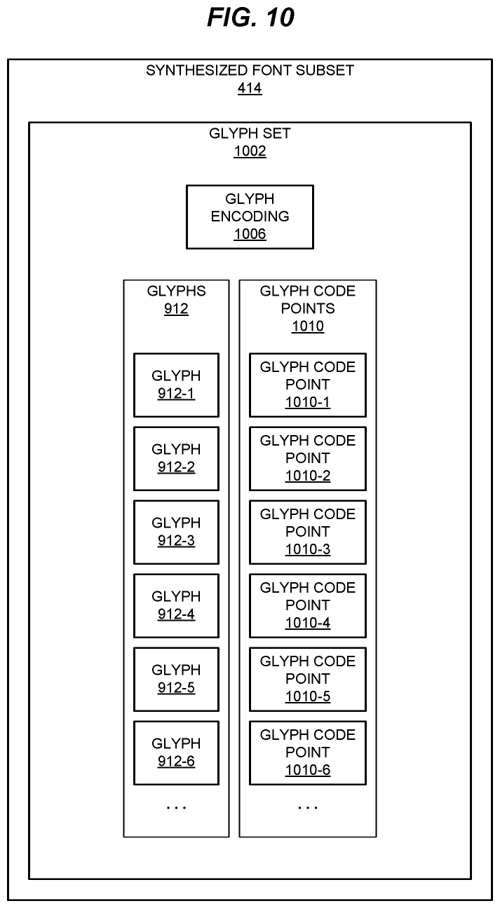

FIG. 9A is a block diagram illustrating an embedded font 404 in an illustrative embodiment. Embedded font 404 includes a character set 902 comprising one or more characters 904. Each character 904 comprises a code point 910 (also referred to as a character code point) assigned to the character 904 within the context of the embedded font 404. The code points 910 assigned to the characters 904 depend on the character encoding 906 of the embedded font 404. Each character 904 further comprises a glyph 912, which is a graphical representation of the character 904. FIG. 9B illustrates a glyph 912 in an illustrative embodiment. A glyph 912 comprises glyph data 918 that represents a character 904. In an example, glyph data 918 may comprise a bitmap 920 or other graphical representation comprising an array or matrix of pixels 922. One or more of the pixels 922 are marked with a color, shading, etc., to represent a character 904 (i.e., letter “B” in FIG. 9B). In another example, glyph data 918 may comprise a series of draw rules 924 that are used to rasterize the glyph 912 “on the fly”. The draw rules 924 describe the outline of the glyph 912 using an infinitely thin line, which is scaled and transformed as needed to produce larger/smaller font sizes and effects like bold or italics, and the rasterization is then done by filling in the outline based on the resolution of a device.

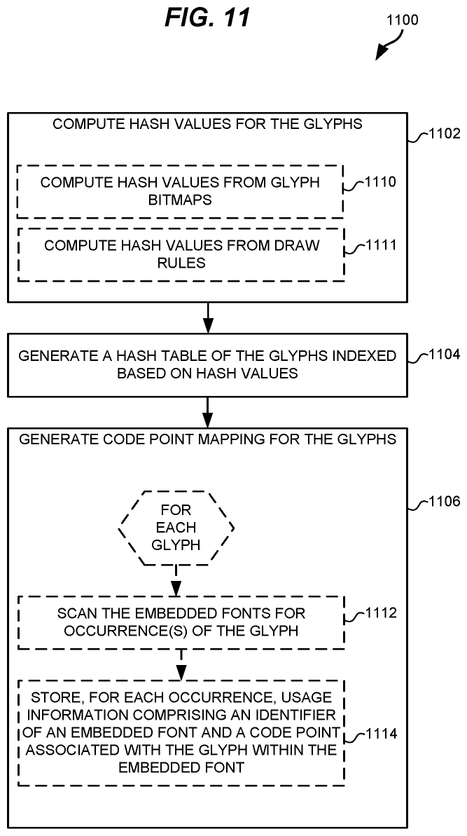

In FIG. 8, font manager 612 generates or builds a synthesized font subset 414 comprising the union of the glyphs 912 found in the embedded fonts 404 (step 806). Font manager 612 assigns code points to the glyphs 912 of the synthesized font subset 414 (step 808). Thus, each distinct glyph 912 of the synthesized font subset 414 is assigned a distinct code point, referred to herein as glyph code points or synthesized font code points. The glyph code points assigned are in the context of the synthesized font subset 414, and may be independent of any code point assignments with the context of the embedded fonts 404. FIG. 10 is a block diagram illustrating a synthesized font subset 414 in an illustrative embodiment. Synthesized font subset 414 includes a glyph set 1002 comprising a plurality of glyphs 912 found in the embedded fonts 404. Font manager 612 assigns a glyph code point 1010 to the glyphs 912 of the synthesized font subset 414 based on a glyph encoding 1006. For example, glyph 912-1 may be assigned glyph code point 1010-1, glyph 912-2 may be assigned glyph code point 1010-2, glyph 912-3 may be assigned glyph code point 1010-3, etc.

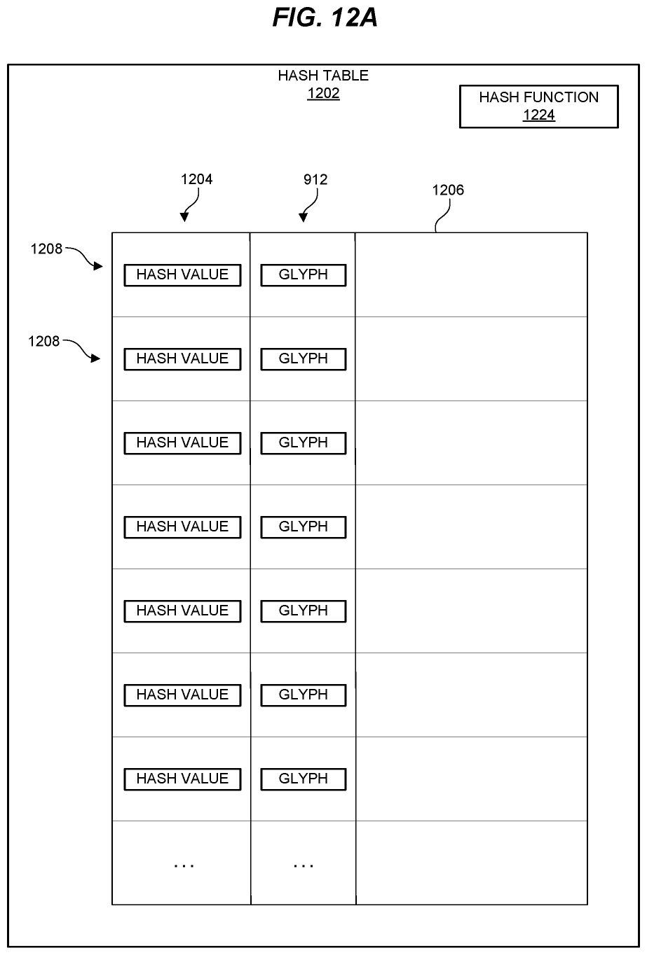

FIG. 11 is a flow chart illustrating a method 1100 of building a synthesized font subset 414 in an illustrative embodiment. Method 1100 will be discussed with respect to font manager 612 of FIG. 6, although method 1100 may be performed by other systems, not shown.

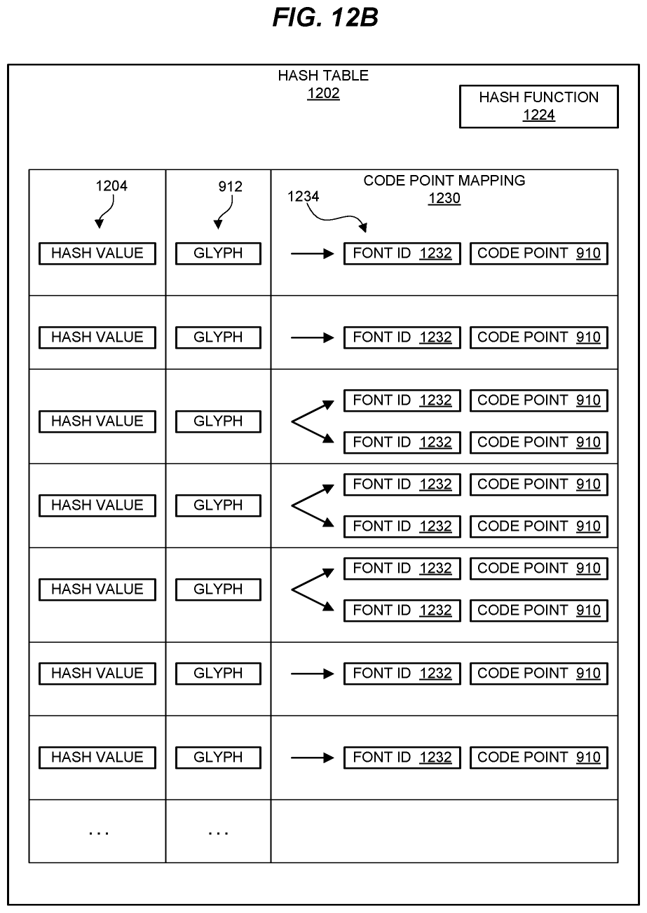

As described above, synthesized font subset 414 comprises the union of the glyphs 912 found in the embedded fonts 404. To identify the union of the glyphs 912, font manager 612 may compute hash values for the glyphs 912 (step 1102), such as to identify each distinct glyph 912 independent of any code point 910 associated with the glyph 912 within the context of the embedded fonts 404. Font manager 612 may then generate a hash table (also referred to as a glyph table, a glyph map, a glyph list, a hash map, etc.) indexed based on the hash values (step 1104). FIG. 12A is a block diagram of a hash table 1202 in an illustrative embodiment. Font manager 612 computes a hash value 1204 for each of the glyphs 912 found in the embedded fonts 404 based on a hash function 1224, and generates the hash table 1202 indexed by the hash values 1204. Hash table 1202 is a data structure 1206 having entries 1208 that store information for glyphs 912. Due to the nature of hashing, the same glyph 912 will produce the same hash value 1204 regardless of any code point 910 associated with the glyph 912, allowing for detection of identical glyphs 912 in the different embedded fonts 404. For example, font manager 612 may compute a hash value 1204 from the glyph data 918 of the glyph bitmap 920 (optional step 1110) or draw rules 924 (optional step 1111), so the same glyphs 912 will produce the same hash value 1204. The entries 1208 of hash table 1202 therefore represent the union of the glyphs 912 without duplicates. One technical benefit is the hash table 1202 lists each distinct glyph 912 found by scanning the embedded fonts 404. Font manager 612 may therefore build the synthesized font subset 414 from the glyphs 912 listed in the hash table 1202 (see step 806 of FIG. 8), and assign code points to the glyphs 912 of the synthesized font subset 414 (see step 808).

In FIG. 11, font manager 612 may further generate a code point mapping for the glyphs 912 (step 1106). A code point mapping is a mapping of a glyph 912 to one or more code points 910 in the embedded fonts 404. FIG. 12B is a block diagram of a hash table 1202 in another illustrative embodiment. As described above in FIG. 9A, characters 904 of an embedded font 404 each comprise a code point 910 assigned to the character 904 with the context of the embedded font 404, and also comprise a glyph 912. The glyphs 912 are therefore associated with the code points 910 assigned to the characters 904 depending on the character encoding 906 of the embedded font 404. To generate the code point mapping 1230, font manager 612 may search for or identify occurrences of the glyphs 912 in the embedded fonts 404 based on the hash values 1204. For each glyph 912 of hash table 1202, font manager 612 may scan the embedded fonts 404 for one or more occurrences of the glyph 912 (optional step 1112). As described above, a glyph 912 in hash table 1202 may have a single occurrence in one of the embedded fonts 404, or may have multiple occurrences across the embedded fonts 404. For each occurrence of the glyph 912, font manager 612 stores usage information 1234 for the glyph 912 (optional step 1114). The usage information 1234 comprises an identifier (i.e., font ID 1232) of the embedded font 404 where the glyph 912 appears, and a code point 910 associated with the glyph 912 within the embedded font 404. In FIG. 12B, for example, the first two glyphs 912 of hash table 1202 have a single occurrence in the embedded fonts 404, and are each mapped to a font ID 1232 of the embedded font 404 where the glyph 912 appears, and a code point 910 associated with the glyph 912 within the embedded font 404. The next three glyphs 912 have multiple occurrences in the embedded fonts 404. Thus, each of these glyphs 912 are mapped to a font ID 1232 of an embedded font 404 and a code point 910 associated with the glyph 912 within the embedded font 404 in relation to a first occurrence of the glyph 912, and are mapped to a font ID 1232 of an embedded font 404 and a code point 910 associated with the glyph 912 within the embedded font 404 in relation to a second occurrence of the glyph 912. One technical benefit is the code point mapping 1230 indicates how glyphs 912 of the hash table 1202 are used within the embedded fonts 404.

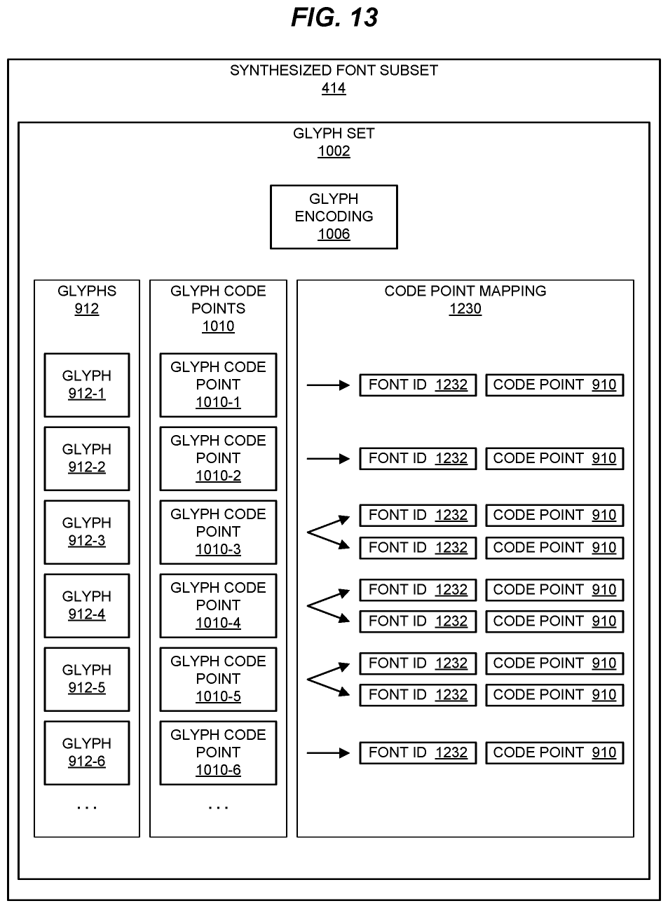

The code point mapping 1230 may be included in the synthesized font subset 414 to modify the combined file 412 (see step 710 of FIG. 7). FIG. 13 is a block diagram illustrating a synthesized font subset 414 in an illustrative embodiment. Synthesized font subset 414 may further include a code point mapping 1230 as described above. When code point mapping 1230 is included in synthesized font subset 414, downstream devices may use the code point mapping 1230 to modify the combined file 412 (i.e., modify the code point references in the combined file 412 to point to the glyph code points 1010). In an alternative, font manager 612 may modify the combined file 412 based on the code point mapping 1230 in the hash table 1202, and the code point mapping 1230 may or may not be excluded from the synthesized font subset 414.

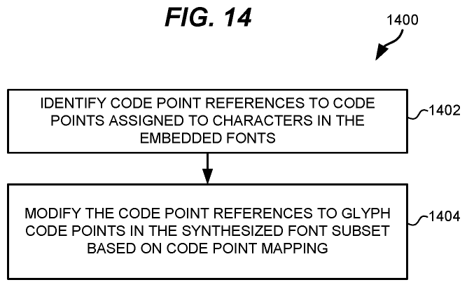

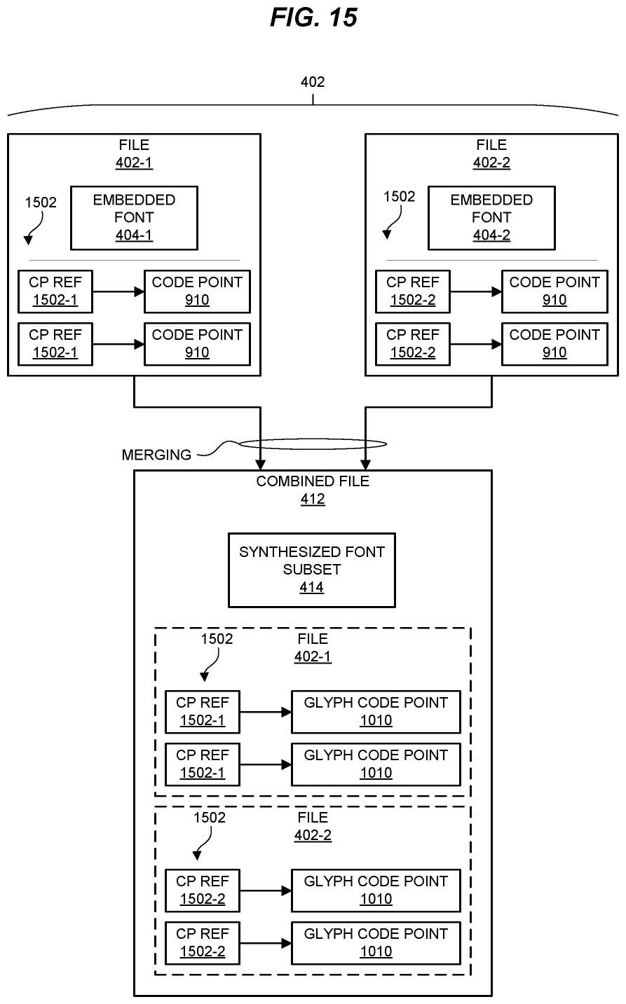

FIG. 14 is a flow chart illustrating a method 1400 of modifying a combined file 412 in an illustrative embodiment. Method 1400 will be discussed with respect to file combiner 610 of FIG. 6, although method 1400 may be performed by other systems, not shown. File combiner 610 identifies code point references in the combined file 412 to code points 910 assigned to characters 904 in the embedded fonts 404 (step 1402). FIG. 15 is a block diagram illustrating file merging in another illustrative embodiment. In this example, electronic file 402-1 and electronic file 402-2 are being merged or combined into a combined file 412. Each of the electronic files 402-1 and 402-2 comprise code point references 1502 to code points 910 in their respective embedded font(s) 404. For example, electronic file 402-1 comprises one or more code point references 1502-1 that point to, are mapped to, or refer to code points 910 within the context of embedded font 404-1, and electronic file 402-2 comprises one or more code point references 1502-2 that point to code points 910 within the context of embedded font 404-2. When file combiner 610 combines the electronic files 402 into the combined file 412 (see step 708 in FIG. 7), file combiner 610 may change the code point references 1502 in the combined file 412. In FIG. 14, for example, file combiner 610 replaces, updates, or modifies the code point references 1502 in the combined file 412 to glyph code points 1010 in synthesized font subset 414 based on the code point mapping 1230 (step 1404). As illustrated in FIG. 15, file combiner 610 modifies the code point references 1502-1 from electronic file 402-1 to glyph code points 1010 within the context of synthesized font subset 414, and modifies the code point references 1502-2 from electronic file 402-2 to glyph code points 1010 within the context of synthesized font subset 414, based on the code point mapping 1230. One technical benefit is the combined file 412 no longer refers to code points 910 from the embedded fonts 404 and instead refers to glyph code points 1010 of the synthesized font subset 414 such that the synthesized font subset 414 may be embedded in the combined file 412 while the embedded fonts 404 may be excluded.

### Example

In the following example, additional processes, systems, and methods may be described in the context of combining electronic files 402. The processes, systems, and methods described in this example may be incorporated in embodiments described above as desired.

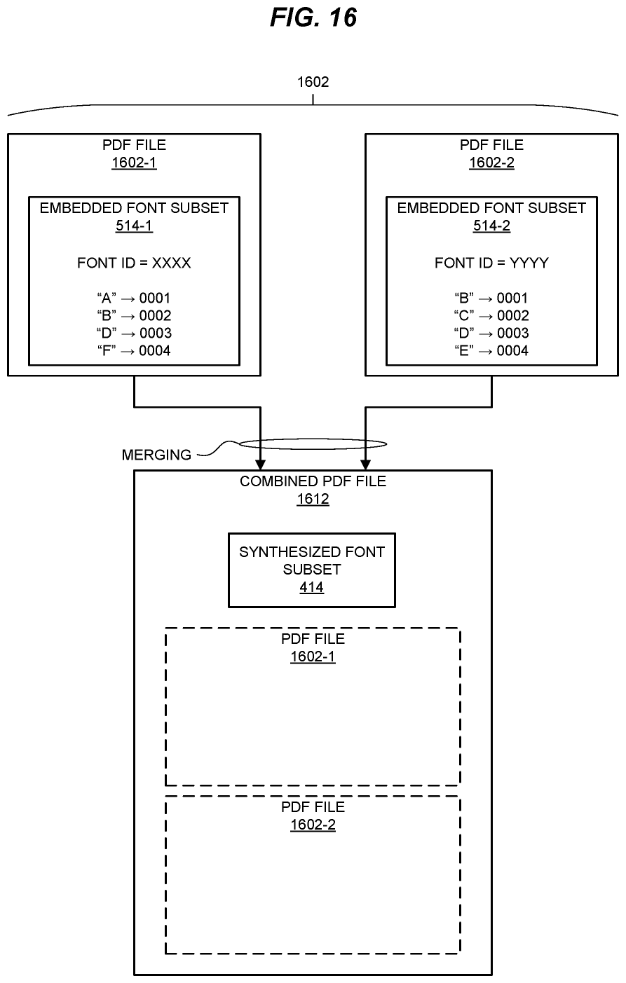

Assume, for example, that file combiner 610 receives two PDF files to combine into a combined PDF file. FIG. 16 is a block diagram illustrating file merging in another illustrative embodiment. Each PDF file 1602-1 and 1602-2 includes its own embedded font subset 514 (e.g., embedded font subset 514-1 and embedded font subset 514-2, respectively) of the same larger source font, and some (but not all) of the glyphs 912 are the same. However, one or more of the glyphs 912 may be associated with different code points 910 in the embedded font subsets 514. For example, embedded font subset 514-1 includes a glyph 912 for “A” that is associated with code point 910 of “0001”, a glyph 912 for “B” that is associated with code point 910 of “0002”, a glyph 912 for “D” that is associated with code point 910 of “0003”, and a glyph 912 for “F” that is associated with code point 910 of “0004”. Meanwhile, embedded font subset 514-2 includes a glyph 912 for “B” that is associated with code point 910 of “0001”, a glyph 912 for “C” that is associated with code point 910 of “0002”, a glyph 912 for “D” that is associated with code point 910 of “0003”, and a glyph 912 for “E” that is associated with code point 910 of “0004”. It is noted that the glyph 912 for “B” is associated with different code points 910 of “0002” and “0001” in the different embedded font subsets 514, and the code point 910 of “0004” is associated with different glyphs 912 for “F” and “E”.

If file combiner 610 were to merge the PDF files 1602-1 and 1602-2 into a single, combined PDF file 1612, and the embedded font subsets 514 were embedded in the combined PDF file 1612, the resulting file would be inefficient as it may embed several duplicates of the glyphs 912 (e.g., such as the glyph 912 for “B” and the glyph 912 for “D”). Further, since context is needed to understand what each code point 910 means, the combined PDF file 1612 would also need to include instructions to indicate which embedded font subset 514 is currently being used. Although a small number of glyphs 912 are illustrated in FIG. 16, in actual usage, a combined PDF file 1612 could include over a million embedded custom fonts when embedded font subsets 514 are included, when actually only a few tens or hundreds of unique glyphs 912 are being used.

In an embodiment, file combiner 610 performs a font merger process to build a synthesized font subset 414 based on the embedded font subsets 514. To do so, font manager 612 (of file combiner 610) identifies the embedded font subsets 514 in the PDF files 1602, and identifies glyphs 912 represented in the embedded font subsets 514. For example, font manager 612 may parse (e.g., automatically) the embedded font subsets 514 to identify each distinct glyph 912 represented or included in the embedded font subsets 514. Font manager 612 then generates or builds a synthesized font subset 414 comprising the union of the glyphs 912 found in the embedded font subsets 514. To do so, font manager 612 uses a hash function 1224 to compute a hash value 1204 for each glyph 912 found in the embedded font subsets 514. Using the hash function 1224, font manager 612 scans the embedded font subsets 514 to compute hash values 1204 for the glyphs 912 found in the embedded font subsets 514. Each distinct glyph 912 will produce a unique hash value 1204, but the same glyphs 912 in different embedded font subsets 514 will produce the same hash value 1204. By stepping through each generated hash value 1204, font manager 612 may add entries 1208 to a hash table 1202 using the hash values 1204 as the keys for the hash table 1202. Duplicate keys will indicate that the associated glyph 912 is the same as one already processed, and that they are the same glyph 912. By saving the glyph 912 in hash table 1202, font manager 612 may retrieve the glyph 912 from its hash value 1204 by a simple lookup in hash table 1202.

Font manager 612 further generates a code point mapping 1230 for the glyphs 912 in hash table 1202. In scanning the embedded font subsets 514, font manager 612 also stores a list of elements that contain the original subset font ID 1232 and the code point 910 of the glyph 912 in that font subset. Thus, when an occurrence of a glyph 912 is detected in an embedded font subset 514, font manager 612 stores usage information 1234 for the glyph 912 in hash table 1202 as a font ID 1232 of the embedded font subset 514 and a code point 910 associated with the glyph 912 in the embedded font subset 514. As the glyph 912 is encountered in other embedded font subsets 514, font manager 612 adds the corresponding elements to the list for that glyph 912, resulting in a list that shows all the usages of that glyph 912 in each embedded font subset 514.

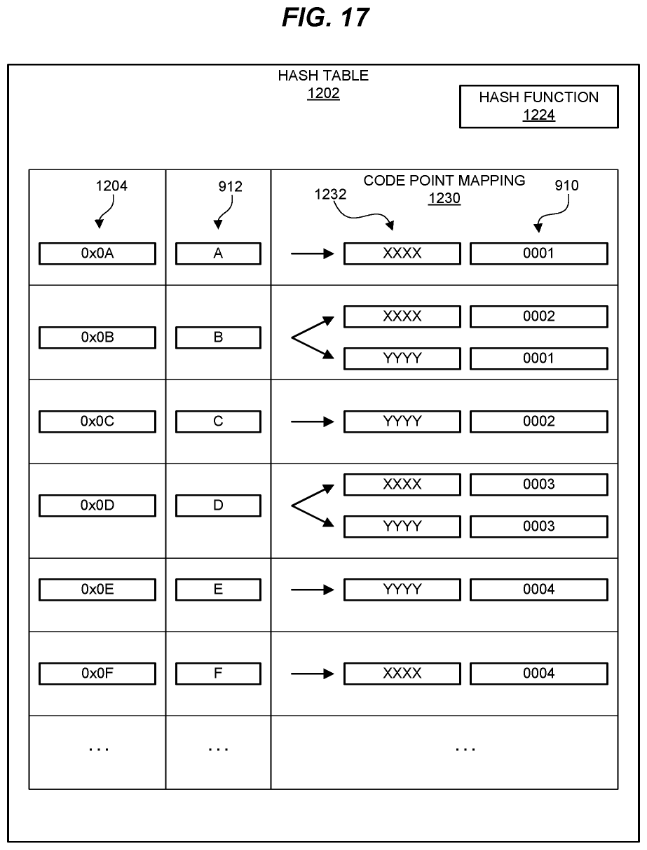

FIG. 17 is a block diagram of a hash table 1202 in another illustrative embodiment. Hash table 1202 is populated with entries 1208 of the glyphs 912 found in embedded font subsets 514 that are indexed by hash value 1204, and includes a code point mapping 1230 to each occurrence of the glyphs 912 in the embedded font subsets 514. In the provided example, the glyph 912 to “A” is used in embedded font subset 514-1 (having a font ID 1232 of “XXXX”) and is assigned a code point of “0001” in embedded font subset 514-1. The glyph 912 to “B” is used in embedded font subset 514-1 (having a font ID 1232 of “XXXX”) and is assigned a code point of “0002” in embedded font subset 514-1, and is also used in embedded font subset 514-2 (having a font ID 1232 of “YYYY”) and is assigned a code point of “0001” in embedded font subset 514-2. The glyph 912 to “C” is used in embedded font subset 514-2 (having a font ID 1232 of “YYYY”) and is assigned a code point of “0002” in embedded font subset 514-2. The glyph 912 to “D” is used in embedded font subset 514-1 (having a font ID 1232 of “XXXX”) and is assigned a code point of “0003” in embedded font subset 514-1, and is also used in embedded font subset 514-2 (having a font ID 1232 of “YYYY”) and is assigned a code point of “0003” in embedded font subset 514-2. The glyph 912 to “E” is used in embedded font subset 514-2 (having a font ID 1232 of “YYYY”) and is assigned a code point of “0004” in embedded font subset 514-2. The glyph 912 to “F” is used in embedded font subset 514-1 (having a font ID 1232 of “XXXX”) and is assigned a code point of “0004” in embedded font subset 514-1.

This example uses a hash function 1224 that simply returns the glyph 912 as a hex-number. In actual operation, the hash function 1224 may be selected to generate a sufficiently large range of hash indices to avoid false “hash collisions”.

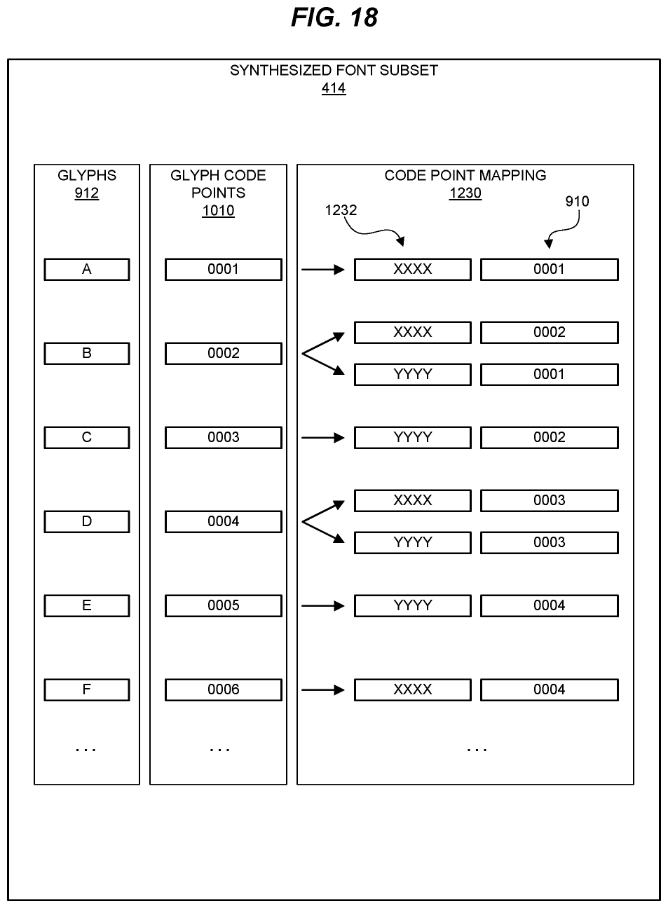

When the hash table 1202 is built, stepping through the keys of the hash table 1202 produces a set of keys with no duplicates. Font manager 612 may use the keys to extract “hash buckets” that contain the associated glyphs 912 and context lists. The resulting set of glyphs 912 is a set of distinct glyphs that can be used to synthesize a new font subset that contains the union of the glyphs 912 used in all of the embedded font subsets 514. FIG. 18 is a block diagram illustrating a synthesized font subset 414 in an illustrative embodiment. Synthesized font subset 414 includes a plurality of glyphs 912 found in the embedded font subsets 514. Font manager 612 assigns a glyph code point 1010 to the glyphs 912 of the synthesized font subset 414 based on a glyph encoding 1006. For example, the glyph 912 to “A” may be assigned a glyph code point 1010 of “0001”, the glyph 912 to “B” may be assigned a glyph code point 1010 of “0002”, the glyph 912 to “C” may be assigned a glyph code point 1010 of “0003”, the glyph 912 to “D” may be assigned a glyph code point 1010 of “0004”, the glyph 912 to “E” may be assigned a glyph code point 1010 of “0005”, and the glyph 912 to “F” may be assigned a glyph code point 1010 of “0006”.

In FIG. 16, file combiner 610 generates a combined PDF file 1612 by combining the individual PDF files 1602. File combiner 610 may modify the combined PDF file 1612 to use the synthesized font subset 414. Generation of the synthesized font subset 414 results in new glyph code points 1010 assigned to the glyphs 912 that are useful only in the context of the synthesized font subset 414. Synthesized font subset 414 may therefore include the code point mapping 1230 as described above. The code point mapping 1230 may be used to transform the code point references 1502 for each character 904 in the combined PDF file 1612 so that they are correct for the synthesized font subset 414 (i.e., each code point reference 1502 refers to a glyph code point 1010 instead of a code point 910 from the embedded font subsets 514), while also setting the context for the combined PDF file 1612 to be the synthesized font subset 414 instead of the embedded font subsets 514. One technical benefit is the resulting combined PDF file 1612 contains a single synthesized font subset 414 that is the union of the glyphs 912 of the original embedded font subsets 514, and contains a single instruction to use the synthesized font subset 414, which reduces the size of the combined PDF file 1612.

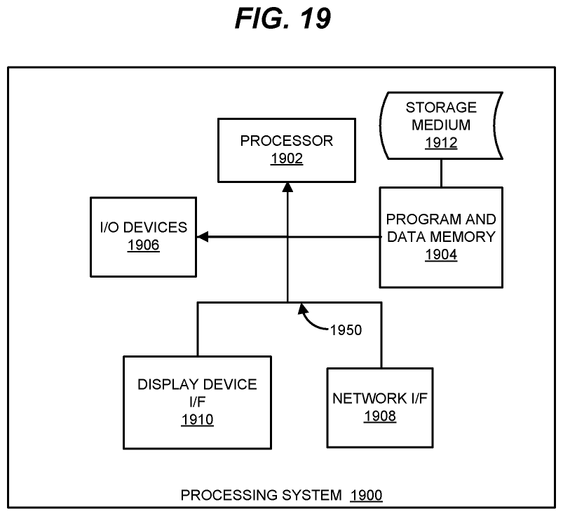

Embodiments disclosed herein can take the form of software, hardware, firmware, or various combinations thereof. FIG. 19 illustrates a processing system 1900 operable to execute a computer readable medium embodying programmed instructions to perform desired functions in an illustrative embodiment. Processing system 1900 is operable to perform the above operations by executing programmed instructions tangibly embodied on computer readable storage medium 1912. In this regard, embodiments of the invention can take the form of a computer program accessible via computer-readable medium 1912 providing program code for use by a computer or any other instruction execution system. For the purposes of this description, computer readable storage medium 1912 can be anything that can contain or store the program for use by the computer.

Computer readable storage medium 1912 can be an electronic, magnetic, optical, electromagnetic, infrared, or semiconductor device. Examples of computer readable storage medium 1912 include a solid-state memory, a magnetic tape, a removable computer diskette, a random-access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1900, being suitable for storing and/or executing the program code, includes at least one processor 1902 coupled to program and data memory 1904 through a system bus 1950. Program and data memory 1904 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1906 (including but not limited to keyboards, displays, pointing devices, etc.) can be coupled either directly or through intervening I/O controllers. Network adapter interfaces 1908 may also be integrated with the system to enable processing system 1900 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1910 may be integrated with the system to interface to one or more display devices, such as printing systems and screens for presentation of data generated by processor 1902.

Although specific embodiments were described herein, the scope of the invention is not limited to those specific embodiments. The scope of the invention is defined by the following claims and any equivalents thereof.

What is claimed is:

1. An apparatus, comprising:
at least one processor and memory, wherein the at least one processor is configured to cause the apparatus at least to:
identify embedded fonts in a plurality of electronic files;
identify glyphs represented in the embedded fonts;
generate a synthesized font subset comprising a union of the glyphs found in the embedded fonts; and
assign glyph code points to the glyphs of the synthesized font subset.

2. The apparatus of claim 1, wherein the at least one processor is further configured to cause the apparatus at least to:
compute hash values for the glyphs; and
generate a hash table of the glyphs indexed based on the hash values, wherein entries of the hash table represent the union of the glyphs.

3. The apparatus of claim 2, wherein the at least one processor is further configured to cause the apparatus at least to:
compute the hash values based on at least one of glyph bitmaps and draw rules for the glyphs.

4. The apparatus of claim 2, wherein the at least one processor is further configured to cause the apparatus at least to:
generate a combined file by merging the electronic files; and
embed the synthesized font subset in the combined file.

5. The apparatus of claim 4, wherein the at least one processor is further configured to cause the apparatus at least to:
generate a code point mapping for the glyphs, wherein the code point mapping maps a glyph to one or more character code points in the embedded fonts; and
modify the combined file to use the synthesized font subset based on the code point mapping.

6. The apparatus of claim 5, wherein the at least one processor is further configured to cause the apparatus at least to:
for each glyph of the hash table, scan the embedded fonts for one or more occurrences of the glyph; and
for each occurrence of the glyph, store usage information for the glyph, wherein the usage information comprises an identifier of the embedded font where the glyph appears, and a character code point associated with the glyph within the embedded font.

7. The apparatus of claim 1, wherein:
the electronic files comprise portable document format files.

8. A print system, comprising:
a management server communicatively coupled to one or more printers;
wherein the management server comprises the apparatus of claim 1.

9. A print system, comprising:
a cloud printing service communicatively coupled to one or more printers;
wherein the cloud printing service comprises the apparatus of claim 1.

10. A print system, comprising:
a printer comprising the apparatus of claim 1.

11. A method, comprising:
identifying embedded fonts in a plurality of electronic files;
identifying glyphs represented in the embedded fonts;
generating a synthesized font subset comprising a union of the glyphs found in the embedded fonts; and
assigning glyph code points to the glyphs of the synthesized font subset.

12. The method of claim 11, wherein the generating the synthesized font subset comprises:
computing hash values for the glyphs; and
generating a hash table of the glyphs indexed based on the hash values, wherein entries of the hash table represent the union of the glyphs.

13. The method of claim 12, wherein the computing the hash values comprises:
computing the hash values based on at least one of glyph bitmaps and draw rules for the glyphs.

14. The method of claim 12, further comprising:
generating a combined file by merging the electronic files; and
embedding the synthesized font subset in the combined file.

15. The method of claim 14, further comprising:
generating a code point mapping for the glyphs, wherein the code point mapping maps a glyph to one or more character code points in the embedded fonts; and
modifying the combined file to use the synthesized font subset based on the code point mapping.

16. The method of claim 15, wherein the generating the code point mapping comprises:
for each glyph of the hash table, scanning the embedded fonts for one or more occurrences of the glyph; and
for each occurrence of the glyph, storing usage information for the glyph, wherein the usage information comprises an identifier of the embedded font where the glyph appears, and a character code point associated with the glyph within the embedded font.

17. A non-transitory computer readable medium embodying programmed instructions executed by a processor, wherein the instructions direct the processor to implement a method comprising:
identifying embedded fonts in a plurality of electronic files;
identifying glyphs represented in the embedded fonts;
generating a synthesized font subset comprising a union of the glyphs found in the embedded fonts; and
assigning glyph code points to the glyphs of the synthesized font subset.

18. The computer readable medium of claim 17, wherein the generating the synthesized font subset comprises:
computing hash values for the glyphs; and
generating a hash table of the glyphs indexed based on the hash values, wherein entries of the hash table represent the union of the glyphs.

19. The computer readable medium of claim 18, further comprising:
generating a combined file by merging the electronic files; and
embedding the synthesized font subset in the combined file.

20. The computer readable medium of claim 19, further comprising:
generating a code point mapping for the glyphs, wherein the code point mapping maps a glyph to one or more character code points in the embedded fonts; and
modifying the combined file to use the synthesized font subset based on the code point mapping.
